(19) United States
(12) Patent Application Publication
(10) Pub. No.: US 2016/0202798 A1
(43) Pub. Date: Jul. 14, 2016

(54) TOUCH PANEL SYSTEM AND ELECTRONIC DEVICE

(71) Applicant: SHARP KABUSHIKI KAISHA, Osaka-shi, Osaka (JP)

(72) Inventor: Takashi ISHIKAWA, Osaka-shi, Osaka (JP)

(73) Assignee: SHARP KABUSHIKI KAISHA, Osaka-shi, Osaka (JP)

(21) Appl. No.: 14/912,674

(22) PCT Filed: Jun. 23, 2014
(86) PCT No.: PCT/JP2014/003357

§ 371 Date: Feb. 18, 2016

(30) Foreign Application Priority Data
Sep. 12, 2013 (JP) 2013-189659

(51) Int. Cl. G06F 3/044; G06F 3/041

(52) U.S. Cl. CPC G06F 3/044; G06F 3/0418

(57) ABSTRACT

Influence of noise is reduced and accuracy of a capacitance value to be detected is improved. A drive wire layer 51 and a drive wire layer 52 which are obtained by dividing a drive wire group (for example, a plurality of drive wires DL) into two, and a sense wire layer 54 and a sense wire layer 55 which are obtained by dividing a sense wire group (for example, a plurality of sense wires SL) into two are vertically divided, and a ground plane layer 53 is disposed between the drive wire layers and the sense wire layers, and in order to take a difference between adjacent sense wires SL for removing noise, any of ends at a break of an arrangement number, at which continuity of the plurality of sense wires SL is lost (here, the fifty-first sense wire SL), is arranged in both of the upper and lower layers.

### TECHNICAL FIELD

The present invention relates to a touch panel system for performing a position input operation, and an electronic device using the same, such as a PC (personal computer) or a tablet terminal.

### BACKGROUND ART

Conventionally, there is a capacitive touch panel mounted on a display screen of a display apparatus. This touch panel is a capacitance detection apparatus for detecting distribution of capacitance values of a capacitance matrix formed between M drive lines DL and L sense lines SL orthogonal thereto, and is an apparatus for detecting a change of a capacitance caused by a touch operation.

In the conventional touch panel as the capacitance detection apparatus, when a pointer such as a finger or a touch pen touches or approaches a surface of the touch panel, a capacitance value at a touched or approached position changes. With this change, the capacitance value which is changed is detected, and the position at which a touch operation is performed with the finger or the touch pen is detected as a coordinate.

In a conventional touch panel system, one end of a flexible substrate is connected to a plurality of drive lines and a plurality of sense lines of a touch panel which is provided on a display screen for image display and is used for position detection, and the other end of the flexible substrate is connected to a control substrate. A controller unit used for controlling position detection is mounted on the control substrate. Wire arrangement of the control substrate will be described with reference to FIG. 12 and FIG. 13.

FIG. 12 is a plan view illustrating a substrate configuration example for arranging a conventional control substrate in a long and narrow frame region around a touch panel.

In FIG. 12, a conventional control substrate 120 is formed to be long and narrow so as to be able to be housed in the long and narrow frame region around the touch panel. Though not illustrated here, a plurality of sense wires (hereinafter, which are referred to as sense wires on the control substrate) and a plurality of drive wires (hereinafter, which are referred to as drive wires on the control substrate) are provided sequentially at equivalent intervals from connectors 121 and 122 and connected to a controller unit 123. Each of the numbers of the plurality of sense wires and the plurality of drive wires is set as, for example, 136 here. Each of the numbers of the plurality of sense wires and the plurality of drive wires is not limited to the number above, and may be the different number according to a vertical size and a horizontal size of a touch screen. The sense wires and the drive wires may be used in a reversed manner. An external connector 124 is able to be connected to an external device.

FIG. 13 is a plan view schematically illustrating an example of a lamination structure of a main part of the conventional control substrate of FIG. 12.

In the conventional control substrate 100 of FIG. 13, a substrate is set as a fourth layer 101 which is a bottom layer, a third layer 102 is provided thereon, a second layer 103 is provided thereon, and a first layer 104 is further provided thereon. The controller unit 123 used for controlling position detection is mounted on the first layer 104. The connectors 121 and 122 are arranged on the first layer 104, and a plurality of sense wires 105 and a plurality of drive wires 106 are arranged between the connectors 121 and 122 and the controller unit 123. The plurality of sense wires 105 and the plurality of drive wires 106 are respectively provided at mutually equivalent intervals and may have the same or different numbers.

A ground plane wire is provided on the second layer 103. Various wires such as a power supply circuit and a driving circuit are provided on the third layer 102 under the second layer 103. In the fourth layer 101 under the third layer 102, various wires such as wires extending over signal wires other than the wires thereof are provided. An insulating layer (protection film) called a resist is formed on a metal layer of each of the first layer 104 and the fourth layer 101.

Since the plurality of sense wires 105 are arranged at mutually equivalent intervals and the ground plane wire is provided in the second layer 103 thereunder, by taking a difference between signal values of the adjacent sense wires 105, it is possible to eliminate noise accurately. In this manner, in order to make it possible to remove the noise by taking the difference between signal values from the adjacent sense wires, the adjacent sense wires 105 are provided to be adjacent and at an equivalent interval so as to have the same condition.

Next, another case where noise components are cancelled by a difference of sense wires will be described with reference to FIG. 14 as follows.

FIG. 14 is a block diagram illustrating a basic configuration example of a conventional touch panel system disclosed in PTL 1.

In a conventional touch panel system 200 of FIG. 14, a touch panel 202 is arranged on a display apparatus 201. When the touch panel system 200 is started, a drive line driving circuit 203 applies a potential to each drive line 204 at a prescribed period. At this time, capacitances are formed respectively between a sense line 205 and the drive line 204 and between a sub sense line 206 and the drive line 204. A touch panel controller 207 to which the sense line 205 and the sub sense line 206 are connected detects positions at which the capacitance between the sense line 205 and the drive line 204 changes and the capacitance between the sub sense line 206 and the drive line 204 changes.

On the other hand, a main sensor 208 and a sub sensor 209 of the touch panel 202 are provided so as to be adjacent to each other in the same surface. Therefore, a noise signal value included in an output signal of the main sensor 208 and a noise signal value included in an output signal of the sub sensor 209 may be regarded as being the basically same value.

Thus, a subtraction unit 210 which exists in the touch panel controller 207 executes processing for subtracting an input signal (signal value) from the sub sensor 209 from an input signal (signal value) from the main sensor 208. That is, the subtraction unit 210 takes a difference between the signal values of the sense line 205 and the sub sense line 206. This makes it possible to remove a noise signal from the output signal of the main sensor 208. The noise signal is removed in this manner, and a capacitance signal value derived from a touch operation itself, which is caused by the touch panel operation to the touch panel 202, is obtained.

The signal value subjected to the subtraction processing in this manner (the capacitance signal value derived from the touch operation itself) is output to a coordinate detection unit 211 which exists in the touch panel controller 207.

The coordinate detection unit 211 detects presence/absence of the touch operation by signal processing of the touch operation itself. This makes it possible to suppress a decline in sensitivity of detection of the coordinate detection unit 211 (accuracy of detection of presence/absence of the touch operation). Note that, a CPU 212 controls display of a display apparatus 201 according to a detection result of the coordinate detection unit 211.

In this manner, in the touch panel system 200, the subtraction unit 210 takes a difference between the sense line 205 and the sub sense line 206 for cancelling noise components from the input signal from the sense line 205, which includes various noise components. That is, the subtraction unit 210 is able to remove the noise signal from the input signal from the sense line 205 and extract the signal derived from the touch operation itself.

### CITATION LIST

### Patent Literature

PTL 1: Japanese Patent No. 4955116

### SUMMARY OF INVENTION

### Technical Problem

In the conventional control substrate 100 described in FIG. 13, since the plurality of sense wires 105 are provided at mutually equivalent intervals and the ground plane wire is provided in the second layer 103 thereunder, by taking the difference between signal values of the adjacent sense wires 105, noise is eliminated accurately. Moreover, in the conventional touch panel system 200 of FIG. 14, which is disclosed in PTL 1, noise components are cancelled by the difference between the sense wire 205 and the sub sense wire 206 to suppress noise. In the touch panel system which requires the large number of sense wires and drive wires, the numbers and wiring pitches of the sense wires and the drive wires directly affect an area.

However, in a mobile device for which size and weight reduction is required, the control substrate which is connected to the touch panel and in which the controller unit is mounted needs to be housed in the narrow frame region around the touch panel, so that there is no allowance for an area and the wiring pitch between the sense wires needs to be further reduced. In addition, since the sense wires are difficult to be housed in a single layer and need to be divided into a plurality of layers, a uniform interval between the sense wires is difficult to be kept and there is influence of noise.

The invention is provided for solving the aforementioned conventional problem, and an object thereof is to provide a touch panel system capable of reducing influence of noise and improving accuracy of a capacitance value to be detected, and an electronic device using the touch panel system, such as a PC (personal computer) or a tablet terminal.

### Solution to Problem

A touch panel system of the invention is a touch panel system allowing a position input operation of a pointer, including: a touch panel; a plurality of drive lines and a plurality of sense lines, which are provided in the touch panel and arranged so as to cross each other; a control substrate connected to the touch panel; and a plurality of drive wires and a plurality of sense wires on the control substrate, which are electrically connected to the plurality of drive lines and the plurality of sense lines, respectively; in which the plurality of drive wires and the plurality of sense wires are connected to a controller unit provided on the control substrate, the control substrate is a laminated substrate formed of a plurality of layers, and has a layer in which the plurality of drive wires are arranged, a layer in which the plurality of sense wires are arranged, and at least one layer of a ground plane layer and a power supply layer provided therebetween, and the controller unit is able to detect the input position information by the position input operation of the pointer based on a differential value between signal values obtained from adjacent sense wires connected to adjacent sense lines.

The ground plane layer in such a configuration may be defined as a layer in which a conductor which is spread over an entire area excluding ones wired in a layer serving as the ground plane layer, for the reason that spaces for through holes and a laminated substrate are required in a single layer.

Moreover, in the control substrate formed of the plurality of layers in the touch panel system of the invention, the plurality of sense wires are formed being divided into at least two layers of the control substrate formed of the plurality of layers, and a wire at least at one end among a plurality of sense wires formed in one layer of the two layers is connected to a wire at least at one end or the other end among a plurality of sense wires formed in the other layer.

In this manner, since among the plurality of sense wires which are divided from a single layer to a plurality of layers, the divided sense wire is shared between both of the layers, the adjacent wires are shared not only in the same layer but also in a sensor wire portion to be divided in the respective layers. This makes it possible to acquire (take a difference of) signals between adjacent sense lines and remove noise components.

Further, in the touch panel system of the invention, the plurality of sense wires formed being divided into the at least two layers are formed so as to extend in a same direction or in different directions for each layer, and sense wires shared in the at least two layers are a sense wire at one end in the one layer among the two layers, and a sense wire at an end on a different side or the same side from or as the other end in the one layer.

Further, in the control substrate formed of the plurality of layers in the touch panel system of the invention, the plurality of sense wires are formed being divided into at least two layers of the control substrate formed of the plurality of layers, the plurality of sense wires formed in the two layers are formed sequentially and alternately in one layer and the other layer in order of arrangement thereof, and the controller unit is able to detect input position information of the pointer based on a differential value between signal values of vertically adjacent sense wires which are arranged through a layer of the control substrate.

The touch panel system of the invention is a touch panel system in which a controller unit on a control substrate to which a plurality of drive lines and a plurality of sense lines arranged to cross each other in a touch panel allowing a position input operation of a pointer are connected detects input position information of the pointer based on a differential value obtained from signal values for each of adjacent senses lines, in which the control substrate has a layer in which a plurality of drive wires connected to the plurality of drive lines are arranged, a layer in which a plurality of sense wires connected to the plurality of sense lines are arranged, and at least any of a ground plane layer and a power supply layer provided therebetween, thus making it possible to achieve the aforementioned object.

Moreover, it is preferable in the touch panel system of the invention that at least either the plurality of drive wires or the plurality of sense wires are divided from a single layer into a plurality of layers, and also by sharing the divided sense wires (sense wires whose continuity is lost) in the divided layers, thus the aforementioned object is achieved.

Further, it is preferable in the touch panel system of the invention that at least either the plurality of drive lines or the plurality of sense lines are divided from a single layer into a plurality of layers, and an area in planar view of each of the layers is reduced compared to an area in planar view of the single layer.

Further, it is preferable that a differential value in the touch panel system of the invention is obtained between adjacent sense wires of the same layer or the differential value is obtained between adjacent sense lines of vertically different layers.

Further, it is preferable in the touch panel system of the invention that any of sense wires positioned at a rear end and a front end at a break of consecutive arrangement numbers, at which the plurality of sense wires are divided, is shared in upper and lower layers obtained by dividing into the plurality of layers.

Further, it is preferable that the plurality of sense wires in the touch panel system of the invention are arranged to be divided into upper and lower layers and arranged from one side to the other side in the upper and lower layers, or the plurality of sense wires are arranged to be divided into upper and lower layers and arranged from one side to the other side in one layer and then arranged in a direction opposite to that of the one layer, from the other side to one side in the other layer.

Further, it is preferable that the plurality of sense wires having consecutive arrangement order in the touch panel system of the invention are arranged alternately in the upper and lower layers.

Further, it is preferable in the touch panel system of the invention that a power supply layer of a power supply circuit is provided in addition to the ground plane layer provided therebetween.

Further, it is preferable in the touch panel system of the invention that at least the plurality of the sense wires among the plurality of drive wires and the plurality of sense wires are divided into a plurality of layers, and any of the ground plane layer and the power supply circuit is disposed between the plurality of layers.

An electronic device of the invention allows display according to position input by using the touch panel system of the invention, thus making it possible to achieve the aforementioned object.

With the configuration described above, the effects of the invention will be described below.

The invention provides a touch panel allowing an input operation of a pointer. A plurality of drive lines and a plurality of sense lines are arranged so as to cross each other in a sensor of the touch panel. When a controller unit on a control substrate to which the plurality of drive lines and the plurality of sense lines are connected drives, the plurality of drive lines, a differential value is acquired for each of adjacent sense lines. In a touch panel system for detecting input position information from respective signal values obtained based on the acquired differential value, the control substrate has a layer in which a plurality of drive wires are arranged, a layer in which a plurality of sense wires are arranged, and at least any of a ground plane layer and a power supply layer provided therebetween.

Thereby, the drive wires and the sense wires which are wired only with a single layer respectively are able to be divided into a plurality of layers of a layer for the plurality of drive wires and a layer for the plurality of sense wires. By sharing, in the divided layers, the sense wires whose continuity is lost when dividing the sense wires wired in a single layer into a plurality of layers, it is possible to reduce influence of noise and improve accuracy of a capacitance value to be detected.

### Advantageous Effects of Invention

As described above, according to the invention, at least any of a ground plane layer and a power supply layer is provided between a plurality of drive wires and a plurality of sense wires and a plurality of sense wires whose continuity is lost are shared in a plurality of layers, so that it is possible to reduce influence of noise and improve accuracy of a capacitance value to be detected.

### BRIEF DESCRIPTION OF DRAWINGS

FIG. 1 is a block diagram illustrating an entire configuration example of a touch panel system in Embodiment 1 of the invention.

FIG. 2 is a block diagram illustrating a configuration example of a controller of the touch panel system of FIG. 1.

FIG. 3 schematically illustrates a lamination structure of a main part of a control substrate 5 of FIG. 1.

FIG. 4A is a schematic view illustrating one arrangement example of a plurality of sense wires SL in an upper fourth layer and a lower fifth layer of FIG. 3 with arrangement numbers assigned.

FIG. 4B is a schematic view illustrating another arrangement example of the plurality of sense wires SL in the upper fourth layer and the lower fifth layer of FIG. 3 with arrangement numbers assigned.

FIG. 4C is a schematic view illustrating still another arrangement example of the plurality of sense wires SL in the upper fourth layer and the lower fifth layer of FIG. 3 with arrangement numbers assigned.

FIG. 5 is a cross-sectional view schematically illustrating an example of a lamination structure of the control substrate used in the touch panel system of Embodiment 1.

FIG. 6 Part (a) of FIG. 6 is a schematic view schematically illustrating an example of a lamination structure of a main part of a control substrate used in a touch panel system of Embodiments 1 to 3, and part (b) is a schematic view schematically illustrating an example of a lamination structure of a main part of a control substrate used in a touch panel system of a comparative example.

FIG. 7 is a schematic view illustrating an arrangement example of a plurality of sense wires SL in a fourth layer and a fifth layer of a control substrate in a touch panel system of Embodiment 2 of the invention with arrangement numbers assigned.

FIG. 8 is a schematic view illustrating an arrangement example of a plurality of sense wires SL in a fourth layer and a fifth layer of a control substrate in a touch panel system of Embodiment 3.

FIG. 9 is a schematic view illustrating an example of a lamination structure of a main part of a control substrate in a touch panel system of Embodiment 4 of the invention.

FIG. 10 Part (a) of FIG. 10 is a schematic view schematically illustrating an example of a lamination structure of a main part of a control substrate used in a touch panel system of Embodiment 5, and part (b) is a schematic view illustrating a modified example of the example of the lamination structure of the main part of the part (a).

FIG. 11 is a block diagram illustrating a schematic configuration example of an electronic device using any of the touch panel systems of Embodiments 1 to 5 of the invention as Embodiment 6 of the invention.

FIG. 12 is a plan view illustrating a configuration example of a substrate for arranging a conventional control substrate in a long and narrow frame region around a touch panel.

FIG. 13 is a plan view schematically illustrating an example of a lamination structure of a main part of the conventional control substrate of FIG. 12.

FIG. 14 is a block diagram illustrating a basic configuration example of a conventional touch panel system disclosed in PTL 1.

### REFERENCE SIGNS LIST

1, 1A to 1D touch panel system
2 display apparatus
3 touch panel
4 connection unit
5, 5A to 5D control substrate
50 drive wire layer
51a protection film
51 drive wire layer of first layer
52 drive wire layer of second layer
53 GND layer (ground plane layer) of third layer
54 sense wire layer of fourth layer
55 sense wire layer of fifth layer
56, 57 contact
58 power supply layer of sixth layer
59 substrate of seventh layer
6 controller unit (control unit; Central Processing Unit, CPU)
7 connection cable
8 host terminal (application unit)
61 pointer position detection unit
611 amplification unit
612 signal acquisition unit
613 A/D conversion unit
614 signal processing unit
615 detection reference setting unit
616 position information generation unit
62 drive line driving unit
DL drive line (lower electrode)
SL sense line (upper electrode)
E position of pointer (detection region)
P detection surface
30 electronic device
31 display apparatus control unit (application unit)
32 button switch unit
33 imaging unit
34 sound output unit
35 sound collection unit
36 sound processing unit
37 wireless communication unit
38 antenna
39 wired communication unit
40 storage unit
41 main body control unit

### DESCRIPTION OF EMBODIMENTS

Description will hereinafter be given in detail for Embodiments 1 to 5 of a touch panel system of the invention and Embodiment 6 of an electronic device using any of Embodiments 1 to 5 of the touch panel system, for example, such as a PC (personal computer) or a tablet terminal, with reference to drawings. Note that, from the standpoint of creating the drawings, the thickness and length of each constituent member or the like in each drawing are not limited to the illustrated configuration. In addition, the numbers of sense wires and drive wires do not need to correspond to those of an actual device, and are set as the numbers by considering convenience of illustration and description and are not limited to the illustrated configuration. Further, Embodiments 1 to 5 of the touch panel system of the invention may be modified in various manners within the scope defined by the Claims. That is, embodiments obtained by further combining technical means appropriately modified within the scope defined by the Claims are also encompassed by the technical scope of the invention.

### Embodiment 1

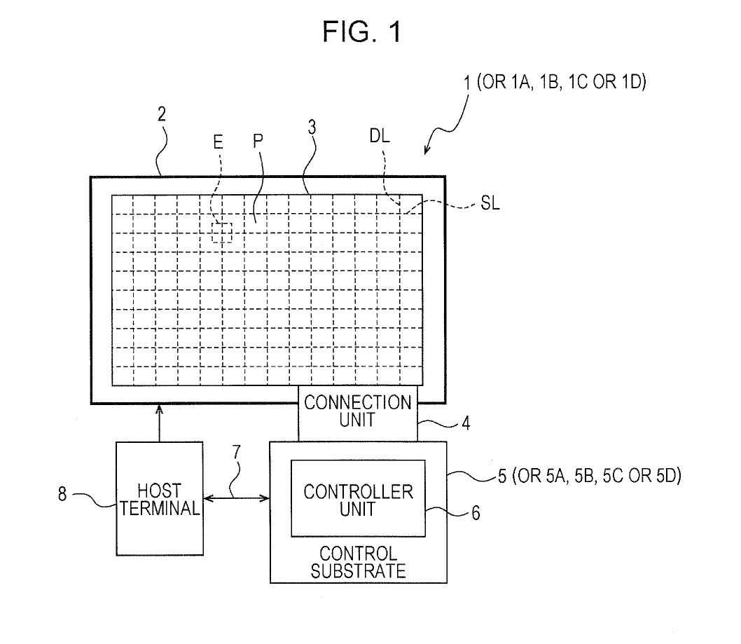

FIG. 1 is a block diagram illustrating an entire configuration example of a touch panel system in Embodiment 1 of the invention.

In FIG. 1, a touch panel system 1 of Embodiment 1 has a display apparatus 2 with a display screen for image display, a touch panel 3 for position detection, which is provided on the display screen, a connection unit 4, such as a flexible print substrate (FPC), connected to the touch panel 3, a control substrate 5 connected to the connection unit 4, a controller unit 6 which is mounted on the control substrate 5 and performs position detection control processing, a connection cable 7 connected to the controller unit 6 through the control substrate 5, and a host terminal 8 which is connected to the controller unit 6 through the connection cable 7, and is connected to the display apparatus 2 for controlling display of the display apparatus 2.

The display apparatus 2 may be merely one in which an image is displayed on a display screen, in addition to, for example, a liquid crystal display (liquid crystal display apparatus), a plasma display, an organic EL display, and a field emission display.

The touch panel 3 has drive lines DL (lower electrode) as X wires, which are provided in parallel to each other along a detection surface P and to each of which a drive signal is provided, and further has sense lines SL (upper electrode) as Y wires, which are provided in parallel to each other along the detection surface P so as to cross the drive lines DL as the X lines (three-dimensional crossing; vertical crossing and crossing at other angle). The touch panel is able to output output signals according to a change of a capacitance due to presence/absence of a pointer (such as a finger or a touch pen) which contacts or is proximate to the touch panel. When the drive lines DL are driven, a plurality of output signals from the plurality of sense lines SL as the Y wires are output through crossing portions of the drive lines DL and the sense lines SL or portions proximate thereto in the detection surface P.

When a pointer such as a finger or a pen contacts or is proximate to a detection region E (crossing portions of the drive lines DL and the sense lines SL or portions proximate thereto; the same will be used hereinafter) in the detection surface P, signals from the sense lines SL change. That is, the signals acquired in the sense lines are signals which indicate three-dimensional coordinate information representing position information of the two-dimensional detection region E (x, y), which indicates whether or not there is contact or proximity to the detection region E, and information of the capacitance (z) by the pointer. As a Z value of the information of the capacitance (z) decreases, a signal level indicating a capacitance value decreases.

The connection unit 4 is composed of an FPC (flexible print) substrate having one end electrically connected to each of electrode lead-out portions of the drive lines DL and the sense lines SL and the other end connected to a circuit terminal of the control substrate 5.

The control substrate 5 has the controller unit 6 in a chip shape mounted at a center portion thereof, and the other end of the FPC substrate as the connection unit 4 is electrically connected to the circuit terminal of the control substrate 5.

The controller unit 6 drives the respective drive lines DL and processes the signals from the respective sense lines SL to detect a position of the pointer (detection region E) in the detection surface P.

The connection cable 7 has one end electrically connected to the circuit terminal of the control substrate 5 which is connected to input and output terminals of the controller unit 6 and the other end electrically connected to the host terminal 8.

The host terminal 8 is composed of a personal computer or the like, and controls the controller unit 6 through the connection cable 7 and controls display of an image, which is displayed on the display screen of the display apparatus 2, based on the position of the pointer (position information (x, y) of the touch detection region E) and the information of the capacitance (z) which are detected by the controller unit 6.

The host terminal 8 connected to the touch panel system 1 may be on a server side like a cloud service, or the touch panel system 1 itself may have a function of the host terminal 8 to control display.

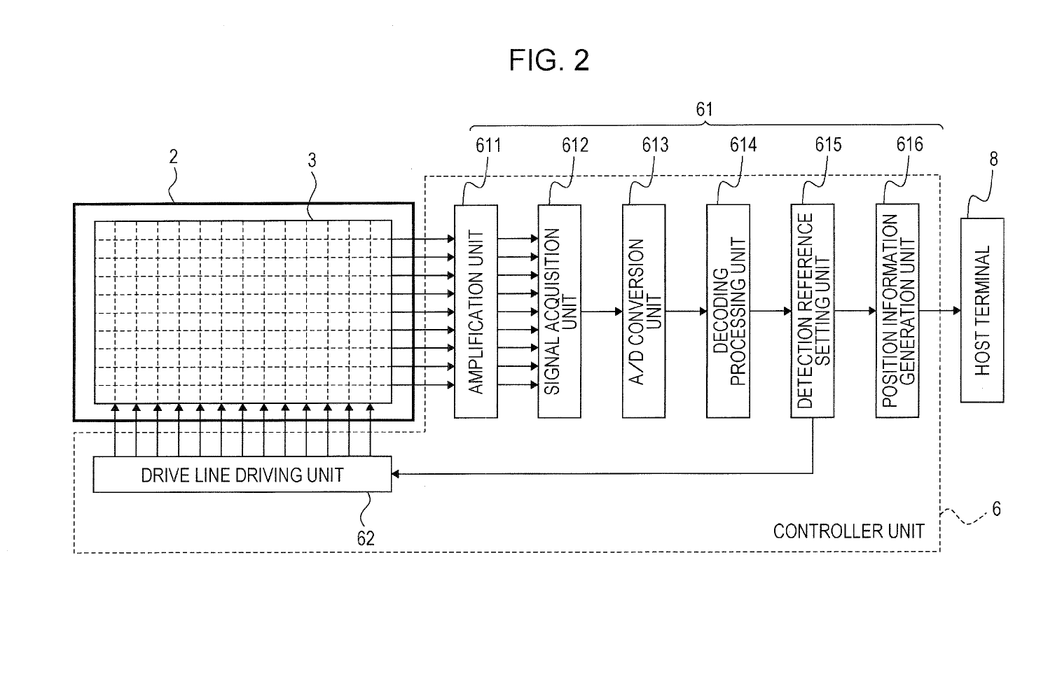

FIG. 2 is a block diagram illustrating a configuration example of the controller 6 of the touch panel system 1 of FIG. 1.

In FIG. 2, the controller unit 6 of Embodiment 1 has a pointer position detection unit 61 for detecting the position of the pointer in the detection surface P (position information (x, y) of the detection region E) and the information of the capacitance (z) by processing a plurality of signals from the plurality of sense lines SL, and a drive line driving unit 62 for sequentially driving the drives DL.

The pointer position detection unit 61 has an amplification unit 611 for amplifying each of the plurality of output signals output from the plurality of sense lines SL, a signal acquisition unit 612 for acquiring the respective output signals amplified by the amplification unit 611 and outputting them by time division, an A/D conversion unit 613 for converting analog signals output by the signal acquisition unit 612 into digital signals, a decoding processing unit 614 for obtaining distribution of an amount of change of the capacitance in the detection surface P based on the digital signals for which A/D conversion is performed by the A/D conversion unit 613, a detection reference setting unit 615 for setting a detection reference value (threshold) which is used when a position information generation unit 616 described below detects the position of the pointer in the detection surface P (position information (x, y) of the detection region E), and the position information generation unit 616 for detecting the position of the pointer in the detection surface P (position information (x, y) of the detection region E) based on the detection reference value with respect to the distribution of the amount of change of the capacitance, which is obtained by the decoding processing unit 614, and generating position information indicating the position of the pointer.

The drive line driving unit 62 outputs predetermined drive signals for each of the plurality of drive lines DL sequentially or simultaneously and drives the plurality of drive lines DL.

On the other hand, from two or more sense lines SL crossing the drive lines DL driven by the drive line driving unit 62, output signals according to a change of a capacitance formed between the drive lines DL and the sense lines SL are acquired by the amplification unit 611.

A difference between output signal values of the output signals amplified by the amplification unit 611 is read from the adjacent sense lines SL by the signal acquisition unit 612. By taking the difference, noise is offset and a coordinate signal level larger than a threshold level (a signal level having five to twenty times of noise components compared to conventional ones) is obtained. This makes it possible to detect a great capacitance value.

The decoding processing unit 614 performs decoding processing for the digital signals, which are obtained from the A/D conversion unit 613, based on signal patterns of the drive signals provided sequentially or simultaneously to the respective drive lines DL by the drive line driving unit 62 to thereby obtain the distribution of the amount of change of the capacitance in the detection surface P.

Before performing detection of the touched position of the pointer, the decoding processing unit 614 acquires digital signals obtained from the respective acquired output signals in a state where there is no pointer (such as a finger or a touch pen) contacting or proximate to the detection surface P, for example, at a time of calibration performed immediately after the touch panel system 1 is started, to thereby obtain two-dimensional distribution of the capacitance in the detection surface P in a state where there is no pointer (such as a finger or a touch pen) contacting or proximate to the detection surface P.

Further, the decoding processing unit 614 compares the distribution of the capacitance in the detection surface P in a state where there is no pointer contacting or proximate to the detection surface P and the distribution of the capacitance in the detection surface P, which is obtained when the position of the pointer is detected, and obtains the distribution of the amount of change of the capacitance in the detection surface P, that is, two-dimensional distribution of components of the capacitance which changes resulting from contacting or proximity of the pointer to the detection surface P.

Further, by subtracting the two-dimensional distribution of the capacitance in the detection surface P in a state where there is no pointer contacting or proximate to the detection surface P from the two-dimensional distribution of the capacitance in the detection surface P, which is obtained when the touch position of the pointer is detected, the decoding processing unit 614 is able to obtain the three-dimensional distribution of the amount of change of the capacitance in the detection surface P to which the pointer contacts or is proximate. Though described below, the three-dimensional distribution of the amount of change of the capacitance corresponds to a three-dimensional coordinate of the capacitance value (x, y, z) including the information of the capacitance value (z), which is obtained when the input position of the pointer (x, y) is indicated to the touch panel 3.

The detection reference setting unit 615 sets a detection reference value (threshold) for the distribution of the amount of change of the capacitance, which is obtained from the decoding processing unit 614. For example, the detection reference (threshold) obtained by the detection reference setting unit 615 is stored in a storage unit (not illustrated).

By using the distribution of the amount of change of the capacitance in the detection surface P, which is obtained by the decoding processing unit 614, and the detection reference, the position information generation unit 616 obtains the position of the pointer in the detection surface P and generates position information.

The position information generation unit 616 obtains the touched position in the distribution of the amount of change of the capacitance in the detection surface P, and when the amount of change of the capacitance at the touched position is larger than the detection reference value, is able to set the touched position as the position of the pointer contacting or proximate to the detection surface P.

The position information generation unit 616 may obtain the touched position (a position at which information of the capacitance (z) is maximum) by using the entire detection region of the capacitance in the detection surface P or obtain the touched position by using a part of the detection region (for example, a portion at which the amount of change of the capacitance is larger than a predetermined threshold). Further, for example, by performing interpolation processing for the amount of change of the capacitance in the detection region near the touched position (or a part in the detection surface), the position information generation unit 616 may obtain the amount of change of the capacitance at the touched position.

The position information generation unit 616 generates and outputs position information indicating the position of the pointer in the detection surface P. At this time, in a case where the position of the pointer contacting or proximate to the detection surface P is not able to be obtained, for example, in a case where there is no pointer contacting or proximate to the detection surface P, the position information generation unit 616 may generate and output the position information indicating that the position of the pointer is not able to be obtained.

In the present application, the plurality of drive lines DL as the X wires and the plurality of sense lines SL as the Y wires may be switched, and the upper electrode may be set as the drive lines DL and the lower electrode may be set as the sense lines SL in FIG. 1.

Further, a function of switching the amplification unit and the driving unit which are connected to the plurality of sense lines SL and the plurality of drive lines DL in the description above may be provided so as to switch functions of the upper electrode and the lower electrode (sense/drive) regularly during an operation of the touch panel.

Next, as the control substrate 5 with a characteristic configuration of Embodiment 1, a lamination structure of the control substrate 5 in which the controller unit 6 of FIG. 1 is mounted will be described.

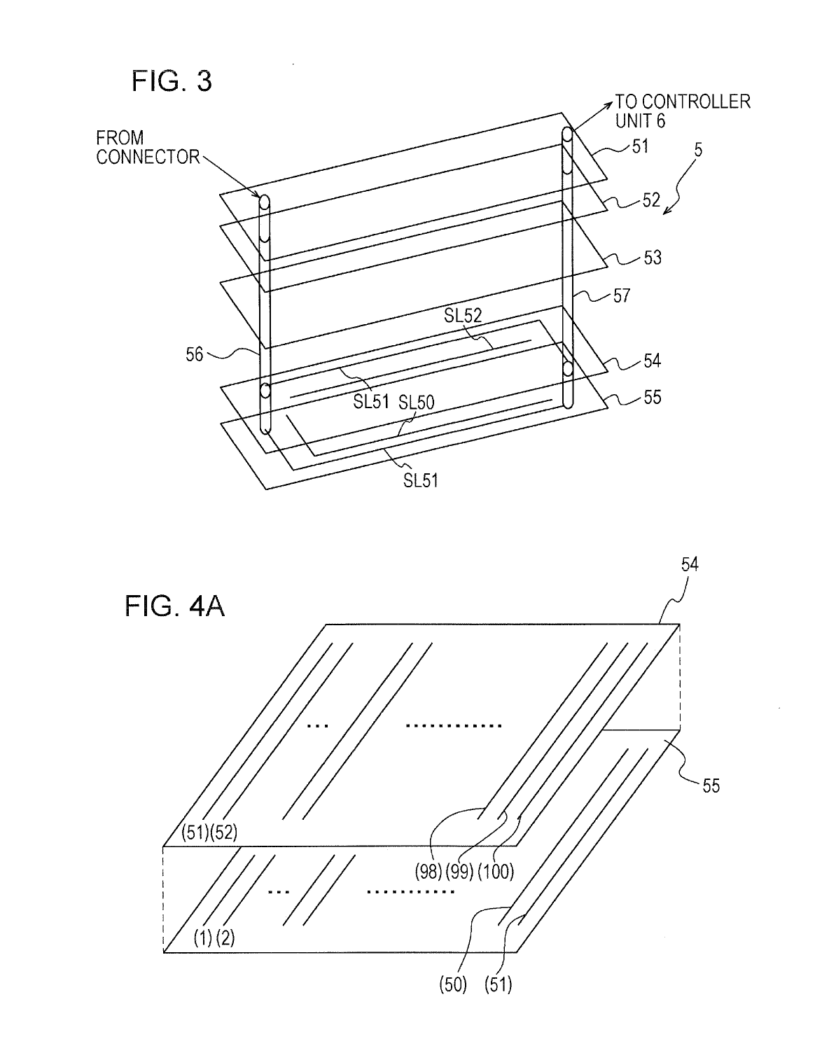

FIG. 3 schematically illustrates a lamination structure of a main part of the control substrate 5 of FIG. 1.

In FIG. 3, in the touch panel system 1 of Embodiment 1, though described above, an input position is indicated by a pointer (such as a finger or a touch pen) to the touch panel 3 in which the plurality of drive lines DL and the plurality of sense lines SL cross each other, and the controller unit 6 on the control substrate 5 to which the plurality of drive lines DL and the plurality of sense lines SL of the touch panel 3 are connected obtains a differential value between respective signal values for each of adjacent sense lines SL and detects input position information of the pointer based on the differential value. In this manner, the touch panel system 1 has the connection unit 4 having one end connected to the touch panel 3 used for detecting input position information, and the control substrate 5 to which the other end of the connection unit 4 is connected through a connector or the like. A lamination structure in which the plurality of drive wires DL and the plurality of sense wires SL are arranged between the connector mounted in the control substrate 5 and the controller unit 6 is provided.

This lamination structure makes it possible to achieve a smaller area of the control substrate in a mobile device for which size and weight reduction is required. In short, the plurality of drive wires DL are divided from a single layer into two upper and lower layers to provide a drive wire layer 51 of a first layer and a drive wire layer 52 of a second layer, and the plurality of sense wires SL are divided from a single layer into two upper and lower layers to provide a sense wire layer 54 of a fourth layer and a sense wire layer 55 of a fifth layer.

When the plurality of drive wires DL and the plurality of sense wires SL having the lamination structure are respectively divided from a single layer into a plurality of layers and a ground plane layer 53 (GND layer) is provided between the drive wires and the sense wires, an area in planar view of each of the layers is reduced more compared to an area in planar view of the single layer and influence of noise is reduced to contribute to improvement of accuracy of a capacitance value to be detected.

Further, the control substrate 5 has the lamination structure in which the ground plane layer 53 of the third layer is disposed between the two upper and lower layers of the plurality of sense wires SL (the sense wire layer 54 of the fourth layer and the Y2 line layer 55 of the fifth layer) and the two upper and lower layers of the plurality of drive wires DL (the drive wire layer 51 of the first layer and the drive wire layer 52 of the second layer).

In short, the drive wire layers and the sense wire layers are arranged being vertically divided into the drive wire layer 51 of the first layer 51 and the drive wire layer 52 of the second layer, and the sense wire layer 54 of the fourth layer and the sense wire layer 55 of the fifth layer, and the ground plane layer 53 is disposed therebetween so as to vertically and electrically separate them.

When the drive wires and the sense wires are laminated, the drive wires and the sense wires run in parallel, and signals of the drive lines become noise for the sense lines through the upper and lower layers. By dividing the drive wires and the sense wires into the respective upper and lower layers and arranging the ground layer therebetween, it is possible to receive little influence of the drive lines.

Contacts 56 and 57 called through holes, in which metal materials are embedded, are provided in the five layers of the first layer to the fifth layer, and the plurality of drive wires DL and the plurality of sense wires SL in each of the layers are respectively connected by the contacts. Specifically, for example, a fifty-first sense wire SL is shared between the sense wire layer 54 of the fourth layer and the sense wire layer 55 of the fifth layer through the contact 56 from the connector of the control substrate 5, and the fifty-first sense wire SL which is shared between the sense wire layer 54 of the fourth layer and the sense wire layer 55 of the fifth layer is connected to the controller unit 6 through the contact 57. The fifty-first sense wire SL is connected from the touch panel 3 and is shared between the sense wire layer 54 of the fourth layer and the sense wire layer 55 of the fifth layer, and the detailed description thereof will be described below.

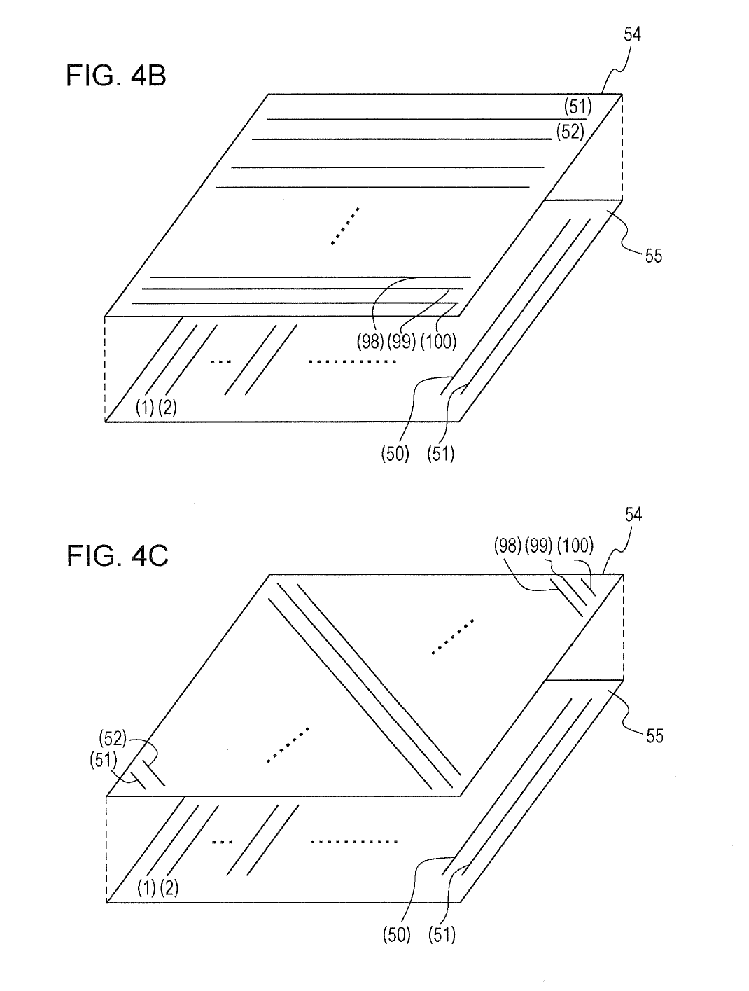

In the sense wire layer 54 of the fourth layer and the sense wire layer 55 of the fifth layer as the two upper and lower layers of the plurality of sense wires SL, as illustrated in FIG. 4A, for example, when one hundred sense lines SL are divided into the two upper and lower layers (the sense wire layer 54 of the fourth layer and the sense wire layer 55 of the fifth layer), for example, into fifty lines and fifty lines to be arranged in parallel, the first to fifty-first sense wires SL are arranged in parallel from the left side to the right side at equivalent intervals in the lower sense wire layer 55 of the fifth layer and the fifty-first to one-hundredth sense wires SL are arranged in parallel from the left side to the right side at equivalent intervals in the upper sense wire layer 54 of the fourth layer.

In short, though described above, the fifty-first sense wire SL is arranged at the end in the sense wire layer 55 of the fifth layer and at the beginning in the sense wire layer 54 of the fourth layer. A line at an end positioned in the sense wire SL (here, fifty-first) at a break at which the plurality of sense wires SL are divided into two and continuity between the upper sense wire layer 54 of the fourth layer and the lower sense wire layer 55 of the fifth layer is lost, is shared between the upper sense wire layer 54 of the fourth layer and the lower sense wire layer 55 of the fifth layer. Though the fifty-first sense wire SL is shared between both of the layers in order to take a difference for offsetting noise, the fiftieth sense wire SL may be shared between both of the upper and lower layers as the end at which continuity is lost.

Thereby, as the adjacent sense wires SL, in the sense wire layer 55 of the fifth layer, a difference is taken between signal values of first and second sense wires SL, and then, a difference is taken between signal values of second and third sense wires SL, . . . , a difference is taken between signal values of forty-ninth and fiftieth sense wires SL, and a difference is taken between signal values of fiftieth and fifty-first sense wires SL, so that noise is eliminated accurately. Further, as the adjacent sense wires SL, in the sense wire layer 54 of the fourth layer, a difference is taken between signal values of fifty-first and fifty-second sense wires SL, . . . , and a difference is taken between signal values of ninety-ninth and one-hundredth sense lines SL, so that noise is eliminated accurately.

In short, the fifty-first sense wire SL at a continuous end is arranged in both of the upper sense wire layer 54 of the fourth layer and the lower sense wire layer 55 of the fifth layer, and a difference is taken between the adjacent sense wires SL in the same layer, thus making it possible to keep continuity. Alternatively, the fiftieth sense wires SL at a continuous end may be arranged in both of the upper sense wire layer 54 of the fourth layer and the lower sense wire layer 55 of the fifth layer, and a difference may be taken between the adjacent sense lines SL in the same layer. Thereby, noise is able to be eliminated accurately under the same condition even in the sense wires which extend over a plurality of layers and continuity is lost, and a differential value is able to be obtained more accurately.

Note that, though description has been given in FIG. 4A above for a case where the sensor wires are arranged in a mutually parallel direction in the upper and lower layers, without limitation thereto, the sensor wires may be arranged in a mutually orthogonal direction in the upper and lower layers as illustrated in FIG. 4B or the sensor wires may be arranged in a mutually inclined direction (for example, at 45 degrees as a crossing angle in planar view) in the upper and lower layers as illustrated in FIG. 4C.

For example, as illustrated in FIG. 4B, in the sense wire layer 54 of the fourth layer and the sense wire layer 55 of the fifth layer as the two upper and lower layers of the plurality of sense wires SL, for example, when one hundred sense lines SL are divided into the two upper and lower layers (the sense wire layer 54 of the fourth layer and the sense wire layer 55 of the fifth layer), for example, into fifty lines and fifty lines to be arranged in parallel, the first to fifty-first sense wires SL are arranged in parallel from the left side to the right side at equivalent intervals in the lower sense wire layer 55 of the fifth layer and the fifty-first to one-hundredth sense wires SL are arranged in parallel from the upper side to the lower side at equivalent intervals in the upper sense wire layer 54 of the fourth layer. The plurality of sense wires SL are arranged to be orthogonal to each other in planar view in the sense wire layer 54 of the fourth layer and the sense wire layer 55 of the fifth layer.

The fifty-first sense wire SL is arranged in both of the sense wire layer 55 of the fifth layer and the sense wire layer 54 of the fourth layer. A line at an end positioned in the sense wire SL (here, fifty-first) at a break at which the plurality of sense wires SL are divided into two and continuity between the upper sense wire layer 54 of the fourth layer and the lower sense wire layer 55 of the fifth layer is lost, is shared between the upper sense wire layer 54 of the fourth layer and the lower sense wire layer 55 of the fifth layer. Though the fifty-first sense wire SL is shared between both of the layers in order to take a difference for offsetting noise, the fiftieth sense wire SL may be shared between both of the upper and lower layers as the end at which continuity is lost.

Similarly, as illustrated in FIG. 4C, in the sense wire layer 54 of the fourth layer and the sense wire layer 55 of the fifth layer as the two upper and lower layers for the plurality of sense wires SL, for example, when one hundred sense lines SL are divided into the two upper and lower layers (the sense wire layer 54 of the fourth layer and the sense wire layer 55 of the fifth layer), for example, into equally fifty lines and fifty lines to be arranged in parallel to each other, the first to fifty-first sense wires SL are arranged in parallel from the left side to the right side at equivalent intervals in the lower sense wire layer 55 of the fifth layer and the fifty-first to one-hundredth sense wires SL are arranged in parallel in a diagonal direction (an oblique direction at an angle of 45 degrees) and in parallel at equal intervals in the diagonal direction in the upper sense wire layer 54 of the fourth layer. The plurality of sense wires SL are arranged to cross each other in an oblique direction (here, at an angle of 45 degrees) in planar view in the sense wire layer 54 of the fourth layer and the sense wire layer 55 of the fifth layer. Of course, on the contrary thereto, the sense wires SL may be arranged in parallel from the left side to the right side at equivalent intervals in the upper sense wire layer 54 of the fourth layer and the sense wire SL may be arranged in parallel at equivalent intervals in a diagonal direction (an oblique direction at an angle of 45 degrees) in the lower sense wire layer 55 of the fifth layer.

In this case as well, the fifty-first sense wire SL is arranged in both of the sense wire layer 55 of the fifth layer and the sense wire layer 54 of the fourth layer. A line at an end positioned in the sense wires SL (here, fifty-first) at a break at which the plurality of sense wires SL are divided into two and continuity between the upper sense wire layer 54 of the fourth layer and the lower sense wire layer 55 of the fifth layer is lost, is shared between the upper sense wire layer 54 of the fourth layer and the lower sense wire layer 55 of the fifth layer. Though the fifty-first sense wire SL is shared between both of the layers in order to take a difference for offsetting noise, the fiftieth sense wire SL may be shared between the upper and lower layers as the end at which continuity is lost.

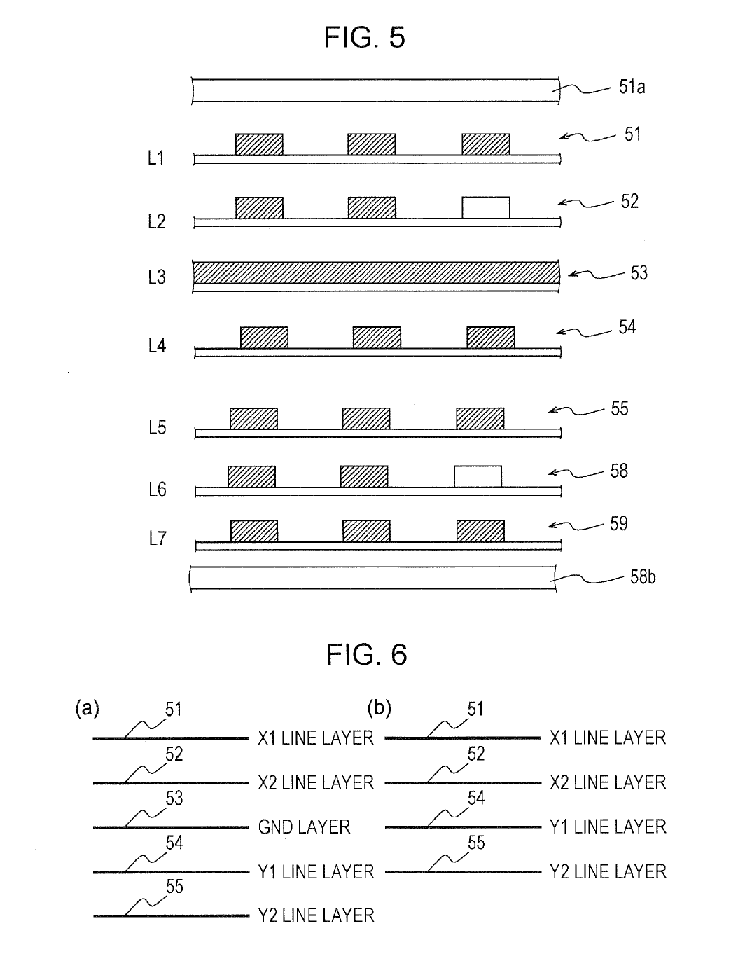

FIG. 5 is a cross-sectional view schematically illustrating an example of the lamination structure of the control substrate 5 used in the touch panel system 1 of Embodiment 1.

To give description in more detail, the lamination structure of the control substrate 5 in FIG. 5 has a protection film 51a and a protection film 58b formed on upper and lower outermost surfaces, and has the drive wire layer 51 of the first layer (L1) and the drive wire layer 52 of the second layer (L2) which are formed by dividing the plurality of drive wires DL into the two layers, the third layer 53 (L3) in which the ground plane layer is provided, the sense wire layer 54 of the fourth layer (L4) and the Y2 line layer 55 of the fifth layer (L5) which are formed by dividing the plurality of sense lines SL into the two layers, a power supply layer 58 of the sixth layer (L6) which is under the Y2 line layer 55 and in which various wires such as a power supply circuit and a driving circuit are provided, and a substrate 59 of the seventh layer (L7) which is under the power supply layer 58 and in which various wires other than the wires above, such as wires extending over signal wires, are provided. In each of the drive wire layer 51 of the first layer to the layer for the various wire layer 59 of the seventh layer, a metal layer (here, Cu layer) having thickness of 20 μm is provided as a wire layer on an insulating layer having thickness of 40 to 60 μm.

By increasing the number of layers to be laminated and decreasing a surface area in planar view compared to a conventional one, the control substrate 5 with the lamination structure is able to be housed in a narrow frame region around the touch panel more easily. As to a distance between the sense wires SL, by increasing number of layers to be laminated, an interval between the lines does not need to be reduced, so that it is possible to suppress influence of noise between the sense lines SL and a parasitic capacitance. Since processing of a through hole is carried out by laser processing with a laser apparatus, the processing is easily carried out when thickness of each layer is thinner. Note that, though there are seven layers in total of the power supply layer 58 of the sixth layer and the substrate 59 of the seventh layer, in which the Cu layer is provided in each of a front surface side, in addition to the drive wire layer 51 of the first layer to the sense wire layer 55 of the fifth layer, without limitation thereto, there may be six layers in total by adding only a substrate 57, in which the Cu layer is provided on the front surface side, to the drive wire layer 51 of the first layer to the sense wire layer 55 of the fifth layer, or may be six layers in total by adding only the power supply layer 58 of the sixth layer, in which the Cu layer is provided on the front surface side. The substrate 57 in which the Cu layer is provided on the front surface side may have various circuits, such as a semiconductor, condenser and a resist, which are mounted. Note that, it is possible to eliminate noise more favorably by arranging the ground plane layer 53 for each line layer, but when the number of the ground plane layers 53 increases, the number of layers to be laminated increases and thickness increases.

As described above, according to Embodiment 1, vertical division is made into the drive wire layer 51 and the drive wire layer 52 which are obtained by dividing a drive wire group (for example, the plurality of drive wires DL) into two, and the sense wire layer 54 and the sense wire layer 55 which are obtained by dividing a sense wire group (for example, the plurality of sense wires SL) into two, and the ground plane layer 53 is disposed between the drive wire layers and the sense wire layers, so that noise is removed. Since a difference is taken from the adjacent sense wires SL, by arranging any break of arrangement numbers, at which continuity of the plurality of sense wires SL is lost (here, the fifty-first sense wire SL), in both of the upper and lower layers, noise is able to be removed even in layers separated from a single layer.

Accordingly, in a mobile device for which size and weight reduction is required, a surface area in planar view of the control substrate 5 which is connected to the touch panel 3 and in which the controller unit 6 is mounted is able to be reduced, and the control substrate 5 is able to be housed in the narrow frame region around the touch panel 3 more easily and allows lamination, so that influence of noise is able to be reduced between the sense lines.

In this manner, it is possible to reduce influence of noise and improve accuracy of a capacitance value to be detected. Further, since the ground plane layer 53 is provided between the drive wire layer 51 of the first layer and the drive wire layer 52 of the second layer, in which the plurality of drive wires DL are arranged, and the sense wire layer 54 of the fourth layer and the sense wire layer 55 of the fifth layer, in which the plurality of sense wires SL are arranged, impedance of the sense wires SL is able to be stabilized.

### Comparative Example

Part (a) of FIG. 6 is a schematic view schematically illustrating an example of a lamination structure of a main part of the control substrate 5 used in the touch panel system 1 of Embodiment 1 above, and part (b) of FIG. 6 is a schematic view schematically illustrating an example of a lamination structure of a main part of a control substrate used in a touch panel system of the present comparative example.

As illustrated in the part (a) of FIG. 6, as the lamination structure provided between the connector and the controller unit 6 which are used in the touch panel system 1 of Embodiment 1 above and are mounted in the control substrate 5 used for detecting a touched position, the drive wire layer 51 of the first layer and the drive wire layer 52 of the second layer obtained by dividing the plurality of drive wires DL into two upper and lower layers, the ground plane layer 53 thereunder, and the sense wire layer 54 of the fourth layer and the sense wire layer 55 of the fifth layer obtained by dividing the plurality of sense wires SL into two upper and lower layers are provided, so that the plurality of drive wires DL and the plurality of sense wires SL are arranged to be electrically and vertically separated and impedance is stabilized.

On the other hand, as illustrated in the part (b) of FIG. 6, the lamination structure of the comparative example has no ground plane layer 53 between them compared to the lamination structure of Embodiment 1 above, and has a four-layer configuration with the drive wire layer 51 of the first layer and the drive wire layer 52 of the second layer obtained by dividing the plurality of drive wires DL into two upper and lower layers, and the sense wire layer 54 of the fourth layer and the sense wire layer 55 of the fifth layer obtained by dividing the plurality of sense wires SL into two upper and lower layers. Though not illustrated, a configuration in which the drive wires DL and the sense wires SL are mixed in the respective layers may be taken.

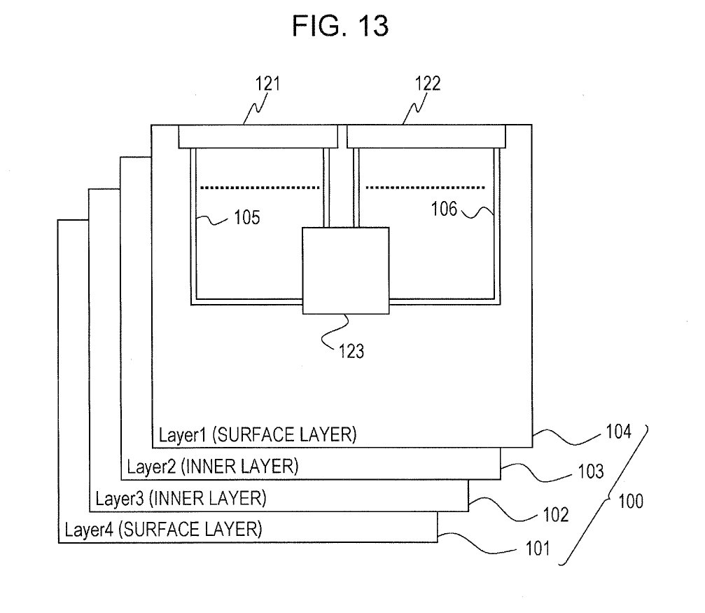

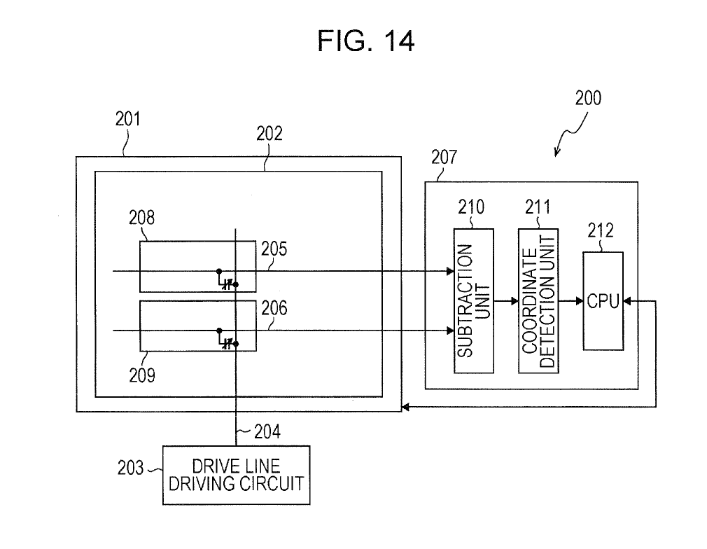

As illustrated in FIG. 13, in a lamination structure of a conventional example, a plurality of drive lines DL and a plurality of sense lines SL are arranged at equal intervals in an outermost first layer 104. In this case, there are about 600 fixed capacitance values regarded as noise as a relative value and can be neglected as noise. Against this, in the lamination structure of the comparative example of the part (b) of FIG. 6 in which there is no ground plane layer 53 between the plurality of drive wires DL and the plurality of sense wires SL, there are about 20000 fixed capacitance values regarded as noise, which are approximately 33 times of 600 as the conventional relative value and has a level which cannot be neglected. They may be detected as noise in some cases. Accordingly, in the lamination structure of the comparative example of the part (b) of FIG. 6 in which there is no ground plane layer 53, the noise cannot be neglected and may be recognized as touch. In this case, an overlapping portion is caused in lines between the plurality of drive wires DL and the plurality of sense wires SL and a fixed capacitance value of a difference is considered as a parasitic capacitance.

On the other hand, in the lamination structure of Embodiment 1 above in which the ground plane layer 53 is used between the plurality of drive wires DL and the plurality of sense wires SL, a fixed capacitance value of a difference is reduced. A noise level thereof can be neglected similarly to the noise of the conventional example.

Accordingly, as Embodiment 1 above, by providing the ground plane layer 53 between the plurality of drive wires DL and the plurality of sense wires SL, influence of a parasitic capacitance between the plurality of drive wires DL and the plurality of sense wires SL is able to be eliminated.

### Embodiment 2

Though description has been given in Embodiment 1 above for a case where the plurality of sense wires SL are arranged to be divided into upper and lower layers, and arrayed sequentially from the left side to the right side in each of the layers, description will be given in Embodiment 2 for a case where the plurality of sense wires SL are arranged from the left side to the right side in the upper layer, and then arrayed sequentially in a reverse direction from the right side to the left side in the lower layer.

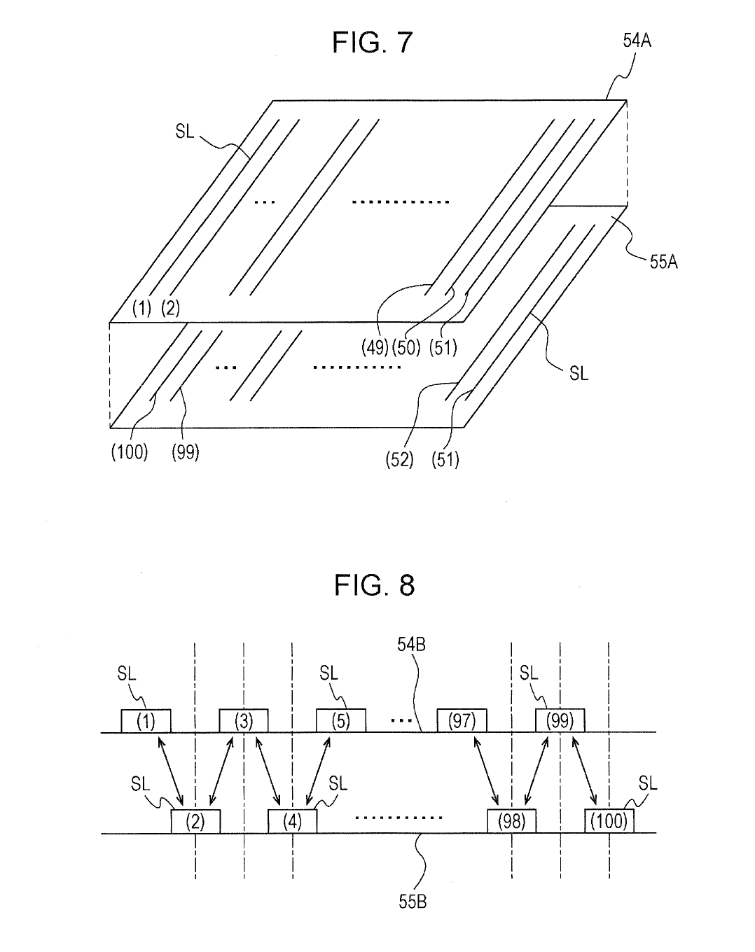

FIG. 7 is a schematic view illustrating an arrangement example of a plurality of sense wires SL in a fourth layer and a fifth layer of a control substrate 5A in a touch panel system 1A of Embodiment 2 of the invention with arrangement numbers assigned. Note that, the similar to the case of Embodiment 1 above is also applied other than the arrangement example of the plurality of sense wires SL.

In FIG. 7, as the arrangement example of the plurality of sense wires SL in a sense wire layer 54A of the fourth layer and a sense wire layer 55A of the fifth layer of the control substrate 5A of Embodiment 2, for example, when one-hundred sense wires SL are divided into two upper and lower layers (the sense wire layer 54A of the fourth layer and the sense wire layer 55A of the fifth layer), for example, into fifty lines and fifty lines, the first to fifty-first sense wires SL are arranged from the left side to the right side at equivalent intervals in the upper sense wire layer 54A of the fourth layer and the fifty-first to one-hundredth sense wires SL are sequentially arranged with an arrangement order from the right side to the left side, which is opposite to that of the upper layer, at equivalent intervals in the lower sense wire layer 55A of the fifth layer. Alternatively, the first to fifty-first sense wires SL may be arranged from the left side to the right side at equivalent intervals in the lower sense wire layer 55A of the fifth layer and the fifty-first to one-hundredth sense wires SL may be arranged with an arrangement order from the right side to the left side, which is opposite to that of the lower layer, in the lower sense wire layer 54A of the fourth layer. In both cases, the fifty-first sense wires SL are arranged to face each other with the same arrangement number assigned in the sense wire layer 54A and the sense wire layer 55A. The arrangement in the upper side and the arrangement in the lower side may be performed in the same direction.

In short, the fifty-first sense wire SL is shared between the sense wire layer 54A of the fourth layer and the sense wire layer 55A of the fifth layer, and the fifty-first sense wire SL having the same arrangement number is arranged at a position of the sense wire layer 55A of the fifth layer, which is directly under the fifty-first sense wire SL arranged in the sense wire layer 54A of the fourth layer. In this case, the fifty-first sense wire SL in the sense wire layer 54A of the fourth layer and the fifty-first sense wire SL in the sense wire layer 55A of the fifth layer are arranged under the same condition so as to face each other closely. This makes it possible to further reduce influence by noise and to obtain a differential value more accurately.

Thereby, as the adjacent sense wires SL, in the sense wire layer 54A of the fourth layer, a difference is taken between signal values of first and second sense wires SL from the left side, and then, a difference is taken between signal values of second and third sense wires SL, . . . , a difference is taken between signal values of forty-ninth and fiftieth sense wires SL, and a difference is taken between signal values of fiftieth and fifty-first sense wires SL, so that noise is eliminated accurately. Further, as the adjacent sense wires SL, in the sense wire layer 55 of the fifth layer, a difference is taken between signal values of fifty-first and fifty-second sense wires SL from the right side, . . . , and a difference is taken between signal values of ninety-ninth and one-hundredth sense wires SL, so that noise is eliminated accurately.

In short, the fifty-first sense wire SL at a continuous end is arranged in both of the upper sense wire layer 54A of the fourth layer and the lower sense wire layer 55A of the fifth layer, and differential values are obtained between the adjacent layers SL in the same layer. Alternatively, the fiftieth sense wire SL at a continuous end may be arranged in both of the upper sense wire layer 54A of the fourth layer and the lower sense wire layer 55A of the fifth layer, and differential values may be taken between the adjacent sense wires SL in the same layer. Thereby, with the respective fifty-first sense wires SL arranged to be close to each other in the upper and lower layers, a difference is hard to be caused in the differential values, and it is possible to obtain the differential values more accurately. Though the fifty-first sense wires SL are arranged so as to be proximate in the upper sense wire layer 54A of the fourth layer and the lower sense wire layer 55A of the fifth layer because of the wires of the control substrate, when such arrangement is difficult, the effect is able to be achieved also by performing arrangement in the upper sense wire layer 54A of the fourth layer and the arrangement in the lower sense wire layer 55A of the fifth layer in the same direction.

As described above, according to Embodiment 2, vertical division is made in the part (a) of FIG. 6 into the drive wire layer 51 and the drive wire layer 52 which are obtained by dividing a drive wire group (for example, the plurality of drive wires DL) into two, and the sense wire layer 54 and the sense wire layer 55 which are obtained by dividing a sense wire group (for example, the plurality of sense wires SL) into two, and the layer 53 which is the ground plane layer (entirely Cu layer) is disposed between the drive wire layers and the sense wire layers, and any of lines at a continuous end, which are the sense wires whose continuity is lost is arranged in both of the upper and lower layers for taking a difference between the adjacent sense wires SL in order to remove noise.

Accordingly, in a mobile device for which size and weight reduction is required, an area in planar view of the control substrate 5A which is connected to the touch panel 3 and in which the controller unit 6 is mounted is able to be reduced, and the control substrate 5A is able to be housed in the narrow frame region around the touch panel 3 more easily, an allowance of an area in planar view is given by the lamination, and an interval between the sense wires SL is able to be increased without reducing a distance therebetween, so that influence of noise is able to be reduced between the sense lines. In this manner, it is possible to reduce influence of noise and improve accuracy of a capacitance value to be detected.

Note that, though description has been given in Embodiment 2 for a case where the plurality of sense wires SL are divided into upper and lower layers and arranged sequentially from the left side to the right side in the upper layer, and then, arranged sequentially from the right side to the left side in a direction opposite to that of the upper layer, without limitation thereto, the plurality of sense wires SL may be divided into upper and lower layers and arranged sequentially from the left side to the right side in the lower layer, and then, arranged sequentially from the right side to the left side in the upper layer in a direction opposite to that of the upper layer. Alternatively, the plurality of sense wires SL may be divided into upper and lower layers and arranged sequentially from the right side to the left side in the upper layer, and then, arranged sequentially from the left side to the right side in the lower layer in a direction opposite to that of the upper layer, or the plurality of sense wires SL may be divided into upper and lower layers and arranged sequentially from the right side to the left side in the lower layer, and then, arranged sequentially from the left side to the right side in a direction opposite to that of the upper layer in the upper layer.

In short, differently from the case of Embodiment 1 above in which the plurality of sense wires SL are divided into upper and lower layers and arranged from one side to the other side in the upper and lower layers, in Embodiment 2, the plurality of sense wires SL are divided into upper and lower layers, and arranged from one side to the other side in one of the layers, and then, arranged from the other side to one side in a direction opposite to that of the one of the layers in the other layer.

### Embodiment 3

Though description has been given in Embodiments 1 and 2 above for a case where differential processing for offsetting noise between two consecutive adjacent sense wires SL is performed with differential processing of the same layer, a case where the differential processing for offsetting noise between two consecutive adjacent sense wires SL is performed with differential processing between upper and lower different layers will be described in Embodiment 3.

FIG. 8 is a schematic view illustrating an arrangement example of a plurality of sense wires SL in a fourth layer and a fifth layer of a control substrate 5B in a touch panel system of Embodiment 3 of the invention. Note that, the similar to the case of Embodiment 1 above is also applied other than the arrangement example of the plurality of sense wires SL.

In FIG. 8, as the arrangement example of the plurality of sense wires SL in a sense wire layer 54B of the fourth layer and a sense wire layer 55B of the fifth layer of the control substrate 5B of Embodiment 3, for example, when one-hundred sense wires SL are distributed alternately and sequentially to upper and lower layers (the sense wire layer 54B of the fourth layer and the sense wire layer 55B of the fifth layer) so as to vertically hold an insulating layer with predetermined thickness of the sense wire layer 54B of the fourth layer, odd-numbered sense wires SL of the first to ninety-ninth sense wires are arranged at equal intervals in a direction from the left side to the right side in the upper sense wire layer 54B of the fourth layer and even-numbered sense wires SL of the second to one-hundredth sense wires are arranged at equal intervals in a direction from the left side to the right side in the lower sense wire layer 55B of the fifth layer, so that the plurality of sense wires SL are arranged alternately in the upper side and the lower side in order of consecutive numbers. At this time, the even-numbered sense wire SL is arranged in the sense wire layer 55B so as to face a center position between the odd-numbered adjacent sense wires SL in the sense wire layer 54B. Moreover, the odd-numbered sense wire SL is arranged in the sense wire layer 54B so as to face a center position between the even-numbered adjacent sense wires SL in the sense wire layer 55B.

In short, since the plurality of consecutive sense wires SL are arranged alternately and sequentially in the upper and lower layers so as to vertically hold the insulating layer of the sense wire layer 54B of the fourth layer by the upper sense wire layer 54B of the fourth layer and the lower sense wire layer 55B of the fifth layer, it becomes unnecessary to share the fifty-first sense wire SL in the upper and lower layers like Embodiments 1 and 2 for a difference used for offsetting noise between the two consecutive sense wires SL. In this case, the differential processing for offsetting noise between the two consecutive sense wires SL is performed between the upper and lower different sense wire layer 54B and sense wire layer 55B.

That is, as the adjacent sense wires SL, a difference is taken between signal values of the first sense wire SL in the sense wire layer 54B of the fourth layer and the second sense wire SL in the sense wire layer 55B of the fifth layer, and then, a difference is taken between signal values of the second sense wire SL in the sense wire layer 55B of the fifth layer and the third sense wire SL in the sense wire layer 54B of the fourth layer, . . . , a difference is taken between signal values of the ninety-eighth sense wire SL in the sense wire layer 55B of the fifth layer and the ninety-ninth sense wire SL in the sense wire layer 54B of the fourth layer, and further, a difference is taken between signal values of the ninety-ninth sense wire SL in the sense wire layer 54B of the fourth layer and the one-hundredth sense wire SL in the sense wire layer 55B of the fifth layer, so that a differential value between the adjacent sense wires SL is able to be obtained under the same stable condition. In this manner, the sense wire SL to be shared is not required.

As described above, according to Embodiment 3, vertical division is made in the part (a) of FIG. 6 into the drive wire layer 51 and the drive wire layer 52 which are obtained by dividing a drive wire group (for example, the plurality of drive wires DL) into two, and the sense wire layer 54 and the sense wire layer 55 which are obtained by dividing a sense wire group (for example, the plurality of sense wires SL) into two, and the GND layer 53 (ground plane layer) which is the ground plane layer (entirely Cu layer) is disposed between the drive wire layers and the sense wire layers, so that influence of noise is reduced, and the adjacent sense wires SL are provided in the upper sense wire layer 54 and the lower sense wire layer 55 and a difference is taken therebetween, so that noise is eliminated with high accuracy.

Accordingly, in a mobile device for which size and weight reduction is required, with the lamination structure of the control substrate 5 in which the controller unit 6 is mounted, a surface area thereof in planar view is able to be reduced compared to a single layer, and the control substrate 5B is able to be housed in the narrow frame region around the touch panel 3 more easily, an allowance of an area in planar view for the control substrate 5 is given, and the sense wires SL are able to be separated without reducing a distance therebetween, so that influence of noise is able to be reduced between the sense lines. In this manner, it is possible to reduce influence of noise and improve accuracy of a capacitance value to be detected.

Note that, though description has been given in Embodiment 3 for a case where, when the plurality of sense lines with the consecutive arrangement order are arranged alternately in upper and lower layers (the sense wire layer 54B of the fourth layer and the sense wire layer 55B of the fifth layer), the even-numbered sense wire SL is arranged in the sense wire layer 55B so as to face a center position between the odd-numbered adjacent sense wires SL in the sense wire layer 54B, and the odd-numbered sense wire SL is arranged in the sense wire layer 54B so as to face a center position between the even-numbered adjacent sense wires SL in the sense wire layer 55B, without limitation thereto, when the plurality of sense lines with the consecutive arrangement order are arranged alternately in upper and lower layers (the sense wire layer 54B of the fourth layer and the sense wire layer 55B of the fifth layer), the even-numbered adjacent sense wires SL may be arranged in the sense wire layer 55B so as to face the odd-numbered adjacent sense wires SL in the sense wire layer 54B.

Note that, though it is configured so that the arrangement position is vertically divided into the drive line layers of the drive wire layer 51 of the first layer and the drive wire layer 52 of the second layer, and the sense lines layers of the sense wire layer 54 of the fourth layer and the sense wire layer 55 of the fifth layer, and the ground plane layer 53 is disposed therebetween so as to electrically and vertically separate them in Embodiments 1 to 3 above, without limitation thereto, it may be configured so that vertical division is made into a drive wire layer of a single layer in which a drive wire group (for example, the plurality of drive wires DL) is arranged, and two layers of the sense wire layer 54 and the sense wire layer 55 in which a sense wire group (for example, the plurality of sense wires SL) is arranged being divided into two, and the ground plane layer 53 is disposed between the drive wire layer and the sense wire layers so as to electrically and vertically separate them. Alternatively, it may be configured so that vertical division is made into the drive wire layer 51 and the drive wire layer 52 which are obtained by dividing a drive wire group (for example, the plurality of drive wires DL) into two, and a sense wire layer of a single layer in which a sense wire group (for example, the plurality of sense wires SL) is arranged, and the GND layer 53 is disposed between the drive wire layers and the sense wire layer so as to electrically and vertically separate them. Further, it may be configured so that vertical division is made into a drive wire layer of a single layer in which a drive wire group (for example, the plurality of drive wires DL) is arranged and a sense wire layer of a single layer in which a sense wire group (for example, the plurality of sense wires SL) is arranged, and the GND layer 53 is disposed between the drive wire layer and the sense wire layer so as to electrically and vertically separate them.

In short, the control substrate has the lamination structure with the layer in which the plurality of drive wires DL are arranged, the layer in which the plurality of sense wires SL are arranged, and the ground plane layer 53 which is provided therebetween.

At least the plurality of drive wires DL or the plurality of sense wires SL are divided from a single layer into a plurality of layers so that an area in planar view of each of the layers is reduced compared to an area in planar view of the single layer, and the plurality of sense lines are arranged in each of the layers. This makes it possible to house the control substrate 5, 5A or 5B in the narrow frame region around the touch panel 3 more easily.

Further, division is made into two upper and lower layers of a drive wire layer of a single layer in which a drive wire group (for example, the plurality of drive wires DL) is arranged and a sense wire layer of a single layer in which a sense wire group (for example, the plurality of sense wires SL) is arranged, so that an area in planar view of each of the divided layers is reduced compared to an area in planar view of the original single layer (the layer in which both of the plurality of drive wires DL and the plurality of sense wires SL are provided), and the plurality of drive wires DL are arranged in one of the layers and the plurality of sense wires SL are arranged in the other layer.

### Embodiment 4

Though description has been given in Embodiments 1 to 3 for a case where vertical division is made in the part (a) of FIG. 6 into the drive wire layer 51 and the drive wire layer 52 which are obtained by dividing a drive wire group (for example, the plurality of drive wires DL) into two, and the sense wire layer 54 and the sense wire layer 55 which are obtained by dividing a sense wire group (for example, the plurality of sense wires SL) into two, and the ground plane layer 53 is disposed between the drive wire layers and the sense wire layers, description will be given in Embodiment 4 for a case where vertical division is made into a drive wire layer of a single layer in which a drive wire group (for example, the plurality of drive wires DL) is arranged, and the two layers of the sense wire layer 54 and the sense wire layer 55 in which a sense wire group (for example, the plurality of sense wires SL) is arranged being divided into two, and not only the ground plane layer 53 but also the power supply layer 58 is disposed between the drive wire layer and the sense wire layers.

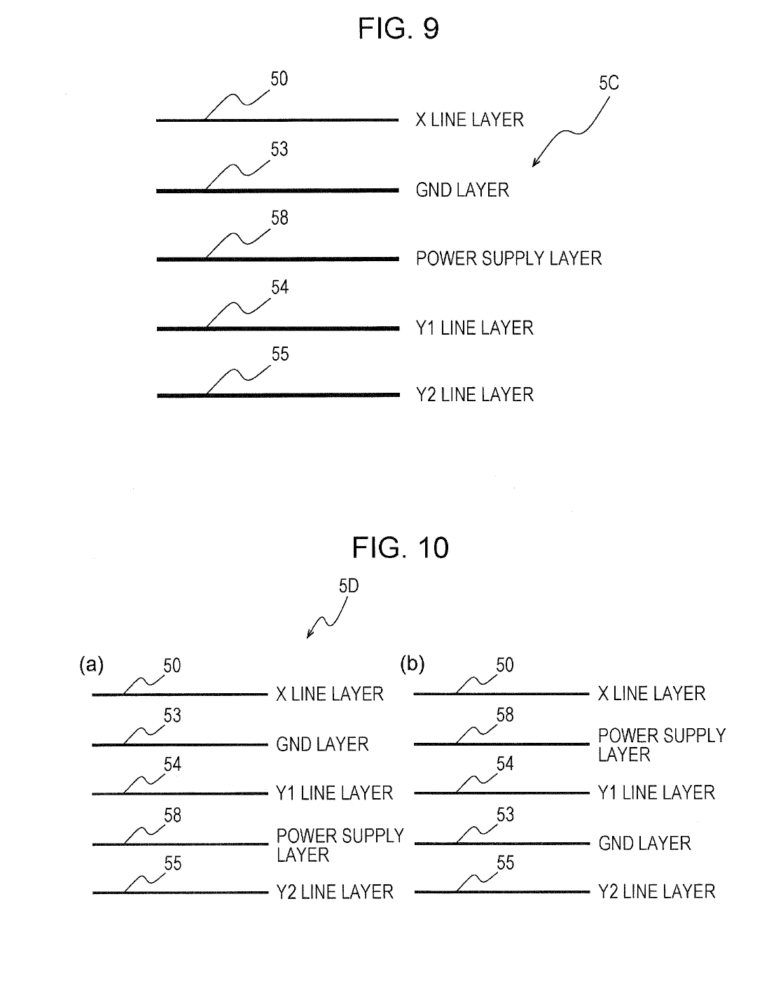

FIG. 9 is a schematic view illustrating an example of a lamination structure of a main part of a control substrate 5C in a touch panel system 1C of Embodiment 4 of the invention. Note that, in FIG. 9, the same reference signs are assigned to constituent members which exert the same effects as those of the constituent members of FIG. 1, and description thereof will be omitted.

In FIG. 9, the lamination structure of the main part of the control substrate 5C in the touch panel system 10 (FIG. 1) of Embodiment 4 has the sense wire layer 54 and the sense wire layer 55 as the fourth layer and the fifth layer, the power supply layer 58 as the third layer thereabove, the ground plane layer 53 as the second layer thereabove, and the drive wire layer 50 as the first layer thereabove.

In short, in addition to the GND layer 53 as the ground plane layer, the power supply layer 58 in which a power supply circuit is formed is disposed between the drive wire layer 50, and the sense wire layer 54 and the sense wire layer 55.

The controller unit 6 used for controlling position detection, the connector which is connected to the connection unit 4 of FIG. 1, and the like are mounted in the drive wire layer 50 of the first layer. The plurality of drive wires DL and the plurality of sense wires SL are arranged between the connector and the controller unit 6 which are mounted in the first layer, and, for example, the plurality of drive wires DL are arranged in the drive wire layer 50 of the first layer and the plurality of sense wires SL are arranged being divided into the two layers of the sense wire layer 54 and the sense wire layer 55 of the fourth layer and the fifth layer through not-illustrated contacts at equal line intervals. The protection film 51a illustrated in FIG. 5 serving as an insulating film which is a protection film is formed directly above metal (such as Cu) of wires and the like in the drive wire layer 50 of the first layer.

Wires are uniformly arranged entirely on the ground plane layer 53 of the second layer. In the power supply layer 58 which serves as the third layer under the second layer, wires such as the power supply circuit are provided. With the ground plane layer 53 of the second layer and the power supply layer 58 of the third layer thereunder, the drive wire layer 50 of the first layer and the sense wire layer 54 and the sense wire layer 55 of the fourth layer and the fifth layer are electrically separated. This makes it possible to take a difference between signal values of the mutually adjacent sense wires SL in the sense wire layer 54 and the sense wire layer 55 and eliminate noise accurately. In order to take a difference between signal values of the adjacent sense wires SL and remove noise, the adjacent sense wires are arranged in parallel at equal intervals to have the same condition.

As the arrangement example of the plurality of sense wires SL, in addition to the arrangement example of the plurality of sense wires SL in the sense wire layer 54 of the fourth layer and the sense wire layer 55 of the fifth layer in the control substrate 5 of Embodiment 1 above (FIG. 4), any of the arrangement example of the plurality of sense wires SL in the sense wire layer 54A of the fourth layer and the sense wire layer 55A of the fifth layer in the control substrate 5A of Embodiment 2 above (FIG. 7), and the arrangement example of the plurality of sense wires SL in the sense wire layer 54B of the fourth layer and the sense wire layer 55B of the fifth layer in the control substrate 5B of Embodiment 3 above (FIG. 8) may be applied to Embodiment 4.

Note that, under the sense wire layer 55 of the fifth layer, the substrate 57 as illustrated in FIG. 5, in which various wires such as wires extending over signal wires other than the wires above may be arranged.

As described above, according to Embodiment 4, vertical division is made into the drive wire layer 50 of a single layer in which a drive wire group (for example, the plurality of drive wires DL) is arranged and two layers of the sense wire layer 54 and the sense wire layer 55 which are obtained by dividing a sense wire group (for example, the plurality of sense wires SL) into two, and two layers of the ground plane layer 53 and the power supply layer 58 are disposed between the drive wire layer 50, and the sense wire layer 54 and the sense wire layer 55, so that the plurality of the drive wires DL and the plurality of sense wires SL are able to be arranged with more distance therebetween and noise is removed more reliably by taking a difference between the adjacent sense wires SL, and therefore, like Embodiments 1 and 2, any of lines at a continuous end (line at a rear end and a line at a front end) in the two upper and lower layers of the sense wire layer 54 and the sense wire layer 55 may be shared in both of the upper and lower layers.

Accordingly, in a mobile device for which size and weight reduction is required, the lamination structure allows reduction of a surface area in planar view of the control substrate 5 which is connected to the touch panel 3 and in which the controller unit 6 is mounted, the control substrate 5 is able to be housed in the narrow frame region around the touch panel 3 more easily, an allowance of an area in planar view is given, and an interval between the sense wires SL is able to be made longer without reducing a distance therebetween, so that influence of noise is able to be reduced between the sense wires. In addition, by disposing the two layers of the ground plane layer 53 and the power supply layer 58 between the plurality of drive wires DL and the plurality of sense wires SL to make a distance therebetween longer, influence of noise is able to be further reduced and accuracy of a capacitance value to be detected is able to be improved.

Since the power supply layer 58 is provided together with the ground plane layer 53 between the drive wire layer 50 of the first layer in which the plurality of drive wires DL are arranged, and the sense wire layer 54 and the sense wire layer 55 of the fourth layer and the fifth layer, in which the plurality of sense wires SL are arranged, it may be configured so that impedance of each of the sense wires SL is further stabilized, and the number of ground plane layers 53 is further reduced to reduce thickness thereof compared to a case where the ground plane layer 53 is provided in each of the layers.

### Embodiment 5

Though description has been given in Embodiment 4 above for a case where vertical division is made into the drive wire layer 50 of a single layer in which a drive wire group (for example, the plurality of drive wires DL) is arranged and two layers of the sense wire layer 54 and the sense wire layer 55 which are obtained by dividing a sense wire group (for example, the plurality of sense wires SL) into two, and the ground plane layer 53 and the power supply layer 58 are disposed between the drive wire layer 50 and the sense wire layers, description will be given in Embodiment 5 for a case where vertical division is made into the drive wire layer 50 of a single layer in which a drive wire group (for example, the plurality of drive wires DL) is arranged and two layers of the sense wire layer 54 and the sense wire layer 55 which are obtained by dividing a sense wire group (for example, the plurality of sense wires SL) into two, and the ground plane layer 53 is disposed between the drive wire layer 50 and the sense wire layers and the power supply layer 58 is disposed between the sense wire layer 54 and the sense wire layer 55.

Part (a) of FIG. 10 is a schematic view schematically illustrating an example of a lamination structure of a main part of a control substrate 5D in a touch panel system 1D of Embodiment 5 of the invention, and the part (b) of FIG. 10 is a schematic view illustrating a modified example of the example of the lamination structure of the main part of the part (a) of FIG. 10. Note that, in the part (a) of FIG. 10 and the part (b) of FIG. 10, the same reference signs are assigned to constituent members which exert the same effects as those of the constituent members of FIG. 1, and description thereof will be omitted.

In the part (a) of FIG. 10, the lamination structure of the main part of the control substrate 5D in the touch panel system 1D (FIG. 1) of Embodiment 5 has the sense wire layer 54 and the sense wire layer 55 as the third layer and the fifth layer, the power supply layer 58 as the fourth layer therebetween, the ground plane layer 53 as the second layer above the sense wire layer 54, and the drive wire layer 50 as the first layer thereabove.

In short, at least the plurality of sense wires SL among the plurality of drive wires DL and the plurality of sense wires SL are divided into a plurality of layers (here, the two layers of the sense wire layer 54 and the sense wire layer 55), and the power supply circuit 58 is disposed between the two layers.

The controller unit 6 used for controlling position detection and the connector which is connected to the connection unit 4 of FIG. 1 are mounted in the drive wire layer 50 of the first layer. The plurality of drive wires DL and the plurality of sense wires SL are arranged between the connector and the controller unit 6 which are mounted in the first layer, and, for example, the plurality of drive wires DL are arranged in the drive wire layer 50 of the first layer and the plurality of sense wires SL are arranged being divided into the two layers of the sense wire layer 54 and the sense wire layer 55 of the third layer and the fifth layer through not-illustrated contacts at equal line intervals. The protection film 51a illustrated in FIG. 5 is formed on the metal layer (Cu layer) and the insulating layer in the drive wire layer 50 of the first layer.

Wires are uniformly arranged entirely on the ground plane layer 53 of the second layer. The power supply circuit is provided in the power supply layer 58. With the ground plane layer 53 of the second layer, the drive wire layer 50 of the first layer and the sense wire layer 54 and the sense wire layer 55 of the third layer and the fifth layer are vertically and electrically separated. In addition, the power supply layer 58 as the fourth layer is disposed between the sense wire layer 54 and the sense wire layer 55 as the third layer and the fifth layer. Thereby, it is possible to take a difference between signal values of the mutually adjacent sense wires SL in the sense wire layer 54 and the sense wire layer 55 and eliminate noise accurately. In order to take a difference between signal values of the adjacent sense wires SL and remove noise, the adjacent sense wires SL are arranged in parallel at equal intervals to have the same condition.

As the arrangement example of the plurality of sense wires SL, in addition to the arrangement example of the plurality of sense wires SL in the sense wire layer 54 of the fourth layer and the sense wire layer 55 of the fifth layer in the control substrate 5 of Embodiment 1 above (FIGS. 4A to C), the arrangement example of the plurality of sense wires SL in the sense wire layer 54A of the fourth layer and the sense wire layer 55A of the fifth layer in the control substrate 5A of Embodiment 2 above (FIG. 7) may be applied to Embodiment 5. Moreover, also as to the arrangement example in which the plurality of sense wires SL are arranged sequentially and alternately in different layers in the sense wire layer 54B of the fourth layer and the sense wire layer 55B of the fifth layer in the control substrate 5B of Embodiment 3 above (FIG. 8), it may be applied as a difference even though the power supply layer 58 is disposed between the sense wire layer 54 and the sense wire layer 55 in Embodiment 5.

Note that, under the sense wire layer 55 of the fifth layer, the substrate 57 as illustrated in FIG. 5 in which various wires such as wires extending over signal wires other than the wires above may be arranged.

As described above, according to Embodiment 5, vertical division is made into the drive wire layer 50 in which a drive wire group (for example, the plurality of drive wires DL) is arranged and the sense wire layer 54 and the sense wire layer 55 which are obtained by dividing a sense wire group (for example, the plurality of sense wires SL) into two, and the ground plane layer 53 is disposed between the drive wire layer 50, and the sense wire layer 54 and the sense wire layer 55, and the power supply layer 58 is also disposed between the sense wire layer 54 and the sense wire layer 55, so that noise is able to be removed more reliably by taking a difference between the adjacent sense wires SL in the same layer, and any of lines at consecutive ends (line at a rear end and a line at a front end) in the two upper and lower layers of the sense wire layer 54 and the sense wire layer 55 is shared in both of the upper and lower layers. Note that, in this case, while the power supply layer 58 and the ground plane layer 53 are arranged as in the part (a) of FIG. 10, the ground plane layer 53 may be arranged instead of the power supply layer 58 and the power supply layer 58 may be arranged instead of the ground plane layer 53 as in the part (b) of FIG. 10.

Accordingly, in a mobile device for which size and weight reduction is required, the lamination structure allows reduction of a surface area in planar view of the control substrate 5D which is connected to the touch panel 3 and in which the controller unit 6 is mounted, the control substrate 5D is able to be housed in the narrow frame region around the touch panel 3 more easily, and with the lamination structure, an allowance of an area in planar view is given and the sense wires SL are able to be separated without reducing a distance therebetween, so that influence of noise is able to be further reduced between the sense lines. In addition, by disposing the ground plane layer 53 between the plurality of drive wires DL and the plurality of sense wires SL and also disposing the power supply layer 58 between the sense wire layer 54 and the sense wire layer 55 to make a distance therebetween greater electrically, influence of noise is able to be further reduced and accuracy of a capacitance value to be detected is able to be improved.

Since the ground plane layer 53 is provided between the drive wire layer 50 of the first layer in which the plurality of drive wires DL are arranged, and the sense wire layer 54 and the sense wire layer 55 of the third layer and the fifth layer in which the plurality of sense wires SL are arranged, and the power supply layer 58 is also provided between the sense wire layer 54 and the sense wire layer 55, impedance of each of the sense wires SL is further stabilized, and the same performance is achieved by the configuration in which the number of GND layers 53 is further reduced to reduce thickness of the lamination structure.

### Embodiment 6

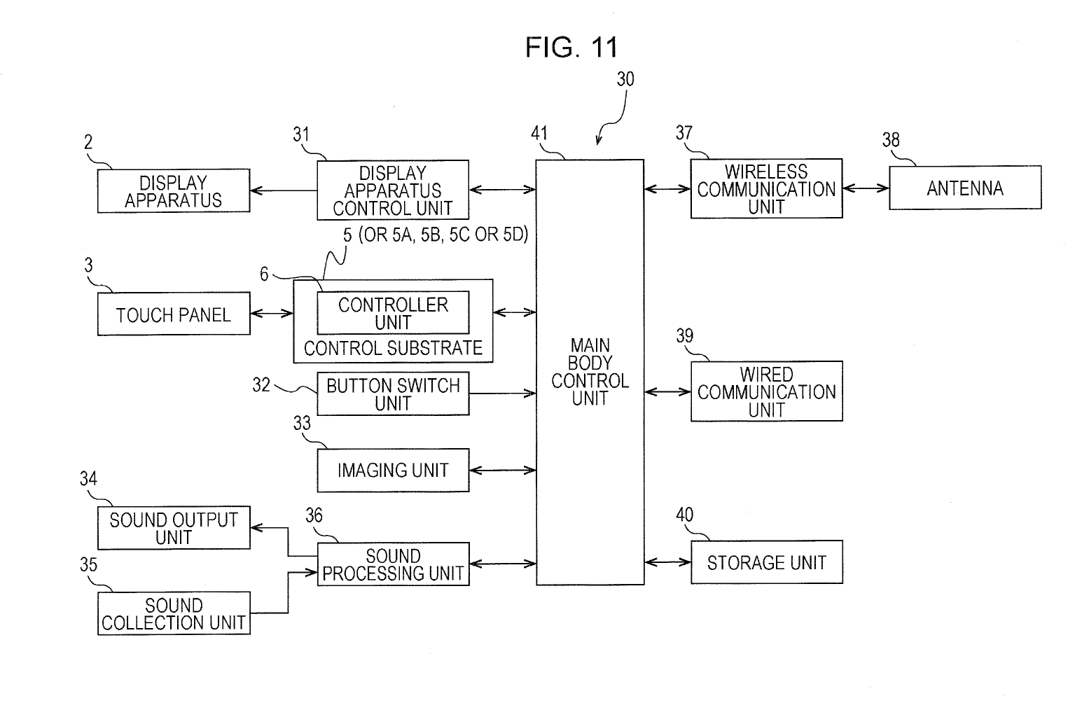

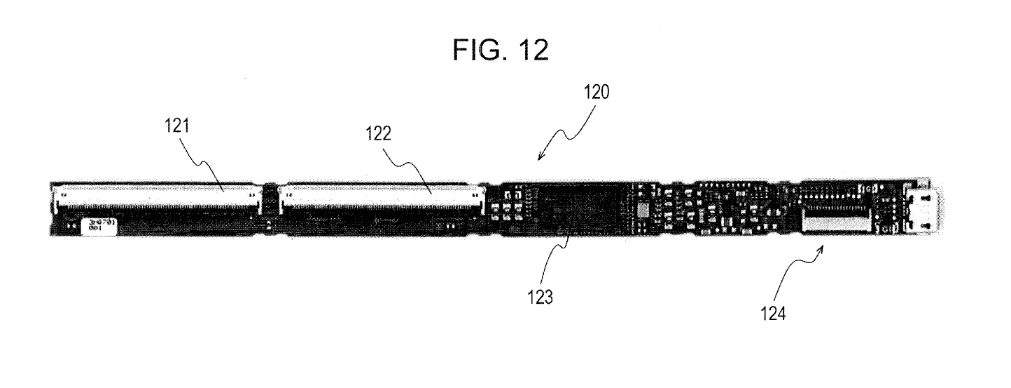

FIG. 11 is a block diagram illustrating a schematic configuration example of an electronic device using any of the touch panel systems 1 and 1A to 1D of Embodiments 1 to 5 of the invention as Embodiment 6 of the invention.

In FIG. 11, an electronic device 30 of Embodiment 6 allows display on a display screen correspondingly to a position input operation by a pointer (such as a finger or a touch pen) by using any of the touch panel systems 1 and 1A to 1D of Embodiments 1 to 5 above.

The electronic device 30 of Embodiment 6 has, as a specific example thereof, the display apparatus 2 of FIG. 1 and FIG. 2; a display apparatus control unit 31 (corresponding to an application unit) for controlling display of the display apparatus 2; the touch panel 3 arranged on the display screen of the display apparatus 2; the control substrate 5, 5A, 5B, 5C or 5D connected to the connection unit 4, such as a flexible print substrate (FPC), connected to the touch panel 3; the controller unit 6 which is mounted in the control substrate 5, 5A, 5B, 5C or 5D and drives the touch panel 3 to detect a touch coordinate of the touch panel 3; a button switch unit 32, such as an on/off switch or a camera switch, for receiving an instruction operation by a user; an imaging unit 33 for allowing generation of image data; a sound output unit 34, such as a speaker, for converting sound data into sound for outputting; a sound collection unit 35, such as a microphone, for collecting sound and converting it into sound data; a sound processing unit 36 for processing sound data to be transmitted to the sound output unit 34 and processing the sound data from the sound collection unit 35; a wireless communication unit 37 for performing wireless communication with an external electronic device; an antenna 38 for transmitting wireless communication data to outside as electromagnetic waves and receiving the electromagnetic waves radiated from the external electronic device; a wired communication unit 39 for performing wired communication with the external electronic device; a storage unit 40 in which various data is stored; and a main body control unit 41 (corresponding to the host terminal 8 of FIG. 1) for controlling operations of the entire device. Note that, the application unit as the display apparatus control unit 31 is included inside the host terminal 8 of FIG. 1. It is needless to say that the controller unit 6 may be included in the main body control unit 41.

Note that, though not particularly described in detail in Embodiments 1 to 5 above, the control substrate has at least any of the ground plane layer 53 and the power supply layer 58 between the layer in which the plurality of drive wires DL are arranged and the layer in which the plurality of sense wires SL are arranged. This makes it possible to achieve the object of the invention that accuracy of a capacitance value to be detected is able to be improved by reducing influence of noise.

Note that, though description has been given in Embodiments 1 to 5 above for a case where it is configured so that at least the plurality of sense wires SL among the plurality of drive wires DL and the plurality of sense wires SL are divided from a single layer into a plurality of layers (here, two layers), and an area in planar view of each of the layers is reduced (made smaller) compared to an area in planar view of the single layer in which both of the plurality of the drive wires DL and the plurality of sense wires SL are arranged, without limitation thereto, it may be configured so that the plurality of drive wires DL among the plurality of drive wires DL and the plurality of sense wires SL are divided from a single layer into a plurality of layers so that an area in planar view of each of the layers is reduced (made smaller) compared to an area in planar view of the single layer. Accordingly, it is only required that it is configured so that at least either the plurality of drive wires DL or the plurality of sense wires SL are divided from a single layer into a plurality of layers, and an area in planar view of each of the layers is reduced (made smaller) compared to an area in planar view of the single layer.

As described above, though the invention is exemplified by the use of preferred Embodiments 1 to 6 of the invention, the invention should not be interpreted solely based on Embodiments 1 to 6. It is understood that the scope of the invention should be interpreted solely based on the claims. It is also understood that those skilled in the art can implement equivalent scope, based on the description of the invention and common knowledge of technology from the description of the detailed preferred Embodiments 1 to 6 of the invention. Furthermore, it is understood that any patent, any patent application and any references cited in the present specification should be incorporated by reference in the present specification in the same manner as the contents are specifically described therein.

### INDUSTRIAL APPLICABILITY

The invention is able to improve accuracy of a capacitance value to be detected by reducing influence of noise in a field of a touch panel system in which touch input is performed at, for example, a predetermined position of a touch panel as a position input operation and display corresponding thereto is performed, and an electronic device using the touch panel system, such as a PC (personal computer) or a tablet terminal.

1. A touch panel system allowing a position input operation of a pointer, comprising:
a touch panel;
a plurality of drive lines and a plurality of sense lines, which are provided in the touch panel and arranged so as to cross each other;
a control substrate connected to the touch panel; and
a plurality of drive wires and a plurality of sense wires on the control substrate, which are electrically connected to the plurality of drive lines and the plurality of sense lines, respectively; wherein
the plurality of drive wires and the plurality of sense wires are connected to a controller unit provided on the control substrate,
the control substrate is a laminated substrate formed of a plurality of layers, and has a layer in which the plurality of drive wires are arranged, a layer in which the plurality of sense wires are arranged, and at least one layer of a ground plane layer and a power supply layer provided therebetween, and
the controller unit is able to detect the input position information by the position input operation of the pointer based on a differential value between signal values obtained from adjacent sense wires connected to adjacent sense lines.

2. The touch panel system according to claim 1, wherein
in the control substrate formed of the plurality of layers,
the plurality of sense wires are formed being divided into at least two layers of the control substrate formed of the plurality of layers, and
a wire at least at one end among a plurality of sense wires formed in one layer of the two layers is connected to a wire at least at one end or the other end among a plurality of sense wires formed in the other layer.

3. The touch panel system according to claim 2, wherein
the plurality of sense wires formed being divided into the at least two layers are formed so as to extend in a same direction or in different directions for each layer, and sense wires shared in the at least two layers are a sense wire at one end in the one layer of the two layers, and a sense wire in the other layer at an end on a different side or a same side from or as the one end in the one layer.

4. The touch panel system according to claim 1, wherein
in the control substrate formed of the plurality of layers,
the plurality of sense wires are formed being divided into at least two layers of the control substrate formed of the plurality of layers,
the plurality of sense wires formed in the two layers are formed sequentially and alternately in one layer and the other layer in order of arrangement thereof, and
the controller unit is able to detect the input position information of the pointer based on a differential value between signal values of vertically adjacent sense wires which are arranged through a layer of the control substrate.

5. An electronic device allowing display according to position input by using the touch panel system according to claim 1.
